(19) United States
(12) Patent Application Publication
(10) Pub. No.: US 2012/0104653 A1
(43) Pub. Date: May 3, 2012

(54) METHOD OF EMBOSSING A SURFACE

(75) Inventor: Mike Brannon, Tupelo, MS (US)

(73) Assignee: INTER-PAC, INC., Tupelo, MS (US)

(21) Appl. No.: 13/271,662

(22) Filed: Oct. 12, 2011

Related U.S. Application Data
(60) Provisional application No. 61/408,086, filed on Oct. 29, 2010.

(51) Int. Cl. B29C 59/04

(52) U.S. Cl. 264/293

(57) ABSTRACT

A method of embossing a sheet of polyethylene foam with a pattern comprises the steps of providing a sheet of polyethylene foam having a surface, providing a heat source positioned to apply heat to the surface of the foam sheet, providing a roller having a surface pattern thereon positioned to contact the surface of the foam sheet, moving the foam sheet past the heat source to apply heat to the surface of the foam sheet, and moving the foam sheet past the roller to emboss the roller surface pattern on the softened surface of the foam sheet.

### RELATED APPLICATIONS

This application claims priority to U.S. Provisional Patent Application Ser. No. 61/408,086 filed Oct. 29, 2010, which is hereby incorporated by reference herein as if fully set forth in its entirety.

### FIELD

The subject matter herein relates generally to methods of embossing surfaces, and more particularly to a method of embossing a surface of polyethylene foam sheet.

### BACKGROUND

Polyethylene foam sheet has been known for some time and has many applications. Two such applications are protective packaging and sports/recreation products.

Polyethylene foam sheet has been used to provide shock and vibration protection for such items as electronics and fruits and vegetables, and to provide surface protection. Polyethylene foam sheet, particularly the anti-static version, is effective in providing shock and vibration protection to electronic equipment such as circuit boards, microchips, computers and other ESD sensitive devices. Polyethylene foam sheet is also effective in protecting fruits and vegetables in harvesting, packaging, and transportation. Polyethylene foam sheet is also effective in protecting the surface finish of a product during shipping and handling. It can provide scratch and dent protection for metal, plastic, glass, and wood surfaces on such products as automotive finishes, television and computer monitors, building panels, furniture, trophies and plaques, and picture frames.

Polyethylene foam sheet can also be used for a number of sports/recreation products. Examples of such products are aerobic steps, archery and dart targets, athletic equipment and wall padding, beverage cooler bags, boat cushions and buoys, car-top boat carriers and racks, exercise and camping mats, floating pool toys and furniture, golf bag and backpack inserts, safety flotation devices, spa and hot tubs, and surf and body boards.

With such a myriad of uses of polyethylene foam sheet, it would be desirable to be able to easily apply a design to the surface of the foam sheet. For example, it would be desirable to apply decorative surface ornamentation to the foam sheet, depending on the nature of the product being fabricated with the foam sheet (or the nature of the use of the foam sheet). As another example, it would be desirable to apply a brand name to the foam sheet, again depending on the nature of the product being fabricated with the foam sheet (or the nature of the use of the foam sheet). As a further example, it would be desirable to apply a “non-slip” or “anti-skid” surface to the foam sheet, for example in the case of the foam sheet being used to fabricate an anti-fatigue mat or the like.

### SUMMARY

Accordingly, the invention is a method of embossing a sheet of polyethylene foam with a pattern comprising the steps of providing a sheet of polyethylene foam having a surface, providing a heat source positioned to apply heat to the surface of the foam sheet, providing a roller having a surface pattern thereon positioned to contact the surface of the foam sheet, moving the foam sheet past the heat source to apply heat to the surface of the foam sheet, and moving the foam sheet past the roller to emboss the roller surface pattern on the softened surface of the foam sheet.

The roller can be heated and be the heat source. Alternatively, the roller can be unheated and the heat source can be separate and upstream from the roller. Alternatively still, the roller can be heated and there can further be an additional heat source separate and upstream from the roller. The foam sheet can be a single layer or multiple layers.

There can be first and second opposed rollers and first and second opposed heat sources, the first and second opposed rollers disposed on opposite sides of the foam sheet, the first and second heat sources disposed on opposite sides of the foam sheet, such that both opposite surfaces of the foam sheet are embossed with the roller surface pattern. The rollers can be heated and be the heat sources. Alternatively, the rollers can be unheated and the heat sources can be separate and upstream from the rollers. Alternatively still, the rollers can be heated and there can further be additional heat sources separate and upstream from the rollers.

The surface pattern can be ornamental, a brand name or trademark, or a non-slip pattern.

### DRAWINGS

FIG. 1 is a schematic side view of the process of the invention.

FIG. 2 is a schematic top view of the process of FIG. 1.

### DESCRIPTION

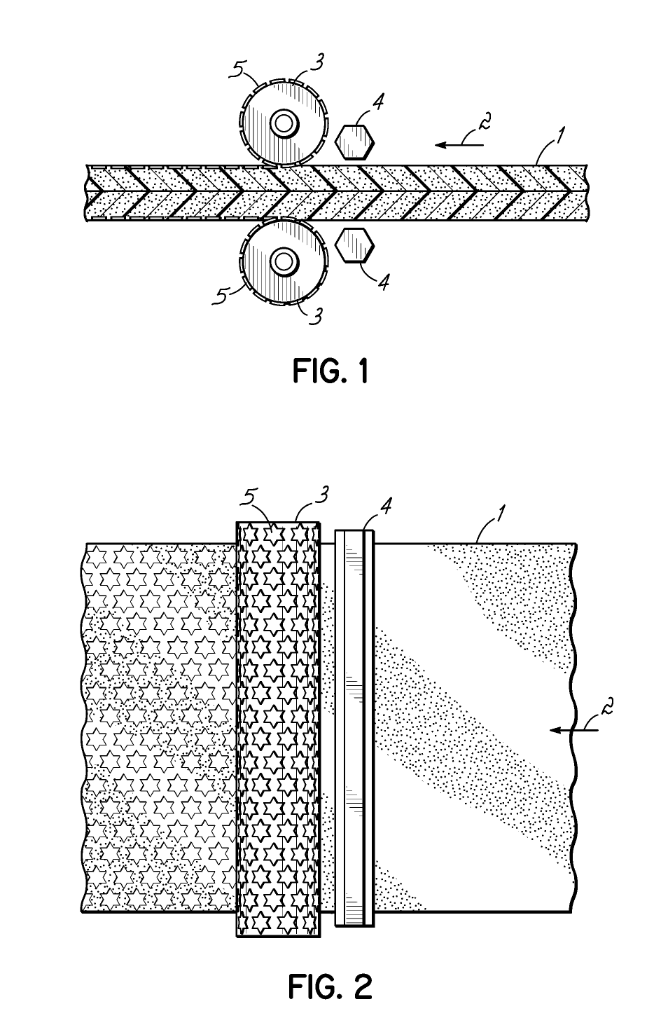

Referring first to FIG. 1, a polyethylene foam sheet 1 is illustrated being processed by the method of the present invention. The foam sheet 1 can be a single layer of foam, two layers of foam (as illustrated), or more than two layers of foam. As illustrated, the foam sheet 1 travels in the direction of arrow 2 between a pair of opposing rollers 3, 3 and between a pair of opposing heat sources 4, 4 upstream of the rollers 3, 3. At least one of the opposing rollers 3, 3 has a surface pattern 5 thereon. The rollers 3, 3 could be heated rollers, either in addition to the heat sources 4, 4 or in lieu thereof. Moreover, in the event that only one surface of the foam sheet 1 is desired to be embossed, only one of the rollers 3, 3 need be heated or only one heat source 4 need be used. As illustrated, the foam sheet 1 will be embossed with the roller surface pattern 5 on both its upper and lower surfaces.

As the foam sheet 1 passes between the heat sources 4, 4, heat is applied to the surface of the foam sheet 1 to soften it. As the foam sheet 1 passes between the rollers 3, 3, the rollers 3, 3 contact the surface of the foam sheet 1 and emboss or otherwise transfer the surface pattern 5 on the rollers 3, 3 into the heat-softened surface of the foam sheet 1. The surface pattern 5 can be an ornamental or decorative pattern so as to impart surface ornamentation to the sheet 1, a brand name or trademark, or a non-slip or anti-skid pattern.

As mentioned above, one or both of the rollers 3, 3 can be the sole heat source, one or two heat sources 4, 4 separate from the rollers 3, 3 can be the sole heat source, or heat can be supplied from one or both of the rollers 3, 3 and one or two heat sources 4, 4. All such variations are deemed to be embraced by the invention.

The embodiments shown and described are merely for illustrative purposes only. The drawings and the description are not intended to limit in any way the scope of the claims. Those skilled in the art will appreciate various changes, modifications, and other embodiments. All such changes, modifications and embodiments are deemed to be embraced by the claims. Accordingly, the scope of the right to exclude shall be limited only by the following claims and their equivalents.

What is claimed is:

1. A method of embossing a sheet of polyethylene foam with a pattern, the method comprising the steps of:
providing a sheet of polyethylene foam having a surface,
providing a heat source positioned to apply heat to the surface of the foam sheet,
providing a roller having a surface pattern thereon positioned to contact the surface of the foam sheet,
moving the foam sheet past the heat source to apply heat to the surface of the foam sheet, and
moving the foam sheet past the roller to emboss the roller surface pattern on the softened surface of the foam sheet.

2. The method of claim 1 wherein the roller is heated and is the heat source.

3. The method of claim 1 wherein the roller is not heated and the heat source is separate and upstream from the roller.

4. The method of claim 1 wherein the roller is heated and further including an additional heat source separate and upstream from the roller.

5. The method of claim 1 wherein the foam sheet is a single layer.

6. The method of claim 1 wherein the foam sheet is multiple layers.

7. The method of claim 1 further including providing first and second opposed rollers and first and second opposed heat sources, the first and second opposed rollers disposed on opposite sides of the foam sheet, the first and second heat sources disposed on opposite sides of the foam sheet, whereby both opposite surfaces of the foam sheet are embossed with the roller surface pattern.

8. The method of claim 7 wherein the rollers are heated and are the heat sources.

9. The method of claim 7 wherein the rollers are not heated and the heat sources are separate and upstream from the rollers.

10. The method of claim 7 wherein the rollers are heated and further including additional heat sources separate and upstream from the rollers.

11. The method of claim 1 wherein the surface pattern is ornamental.

12. The method of claim 1 wherein the surface pattern is a brand name or trademark.

13. The method of claim 1 wherein the surface pattern is a non-slip pattern.
